(19) United States
(12) Patent Application Publication
(10) Pub. No.: US 2025/0084563 A1
(43) Pub. Date: Mar. 13, 2025

(54) LEATHER FIBERS FOR PRODUCT MATERIALS PHYSICALLY EXTRACTED FROM COWHIDE

(71) Applicant: ATKO PLANNING INC., Paju-si, Gyeonggi-do (KR)

(72) Inventors: Ji Eon KIM, Seoul (KR); Bong Jin CHOI, Gwangju-si (KR)

(73) Assignee: ATKO PLANNING INC., Paju-si, Gyeonggi-do (KR)

(21) Appl. No.: 18/288,500

(22) PCT Filed: Oct. 12, 2022
(86) PCT No.: PCT/KR2022/015381

§ 371 Date: Oct. 26, 2023

(51) Int. Cl. D01B 9/00; D01G 5/00

(52) U.S. Cl. CPC D01B 9/00; D01G 5/00; D10B 2211/06

(57) ABSTRACT

The present invention relates to leather fibers for product materials, physically extracted from cowhide, and more specifically, the leather fibers are easily obtained for each length so that there is an advantage in that the leather fibers having different lengths can be respectively used as materials more appropriately for various articles such as leather sheets or yarns.

### TECHNICAL FIELD

The present disclosure relates to leather fibers for product materials, physically extracted from cowhide, and more specifically, the leather fibers are easily obtained for each length so that there is an advantage in that the leather fibers having different lengths can be respectively used as materials more appropriately for various articles such as leather sheets or yarns.

### BACKGROUND ART

Natural leather is a tough shell that surrounds the body of an animal and is widely used in various fields such as bags, shoes, and furniture due to its excellent physical properties. Natural leather is manufactured into a product through chemical and physical processing processes after being separated from the animal's body, and a process of cutting it to fit the design of the desired product among various steps of the processing processes is essential. However, a large amount of leather scraps is generated while the cutting process is being subjected, and most of the leather scraps are disposed by incineration and landfill, and as a result, environmental problems caused by this are seriously emerging. Therefore, various research and development related to the recycling method of leather scraps are required.

As for the conventional method using leather scraps, a method for manufacturing a web-type regenerated leather sheet using collagen fibers generated and discarded during the leather-manufacturing processing process, such as Korean Patent No. 765549 and Patent Publication No. 2018-0118386, is mainly being used.

The above-described conventional technology uses shaving scraps generated during the leather-manufacturing process, and it is not using of scraps leather, that is, a method of utilizing a plate/piece leather scraps substantially discharged as cut scraps or cutting scraps generated in the cutting process, but a technology that uses process by-products generated in the initial stage of forming raw hides into leathers.

Further, Korean Patent No. 2034218 discloses a spun leather yarn containing leather fibers produced by carding mixed fibers in which leather fibers, general fibers, and polymer fibers are mixed to produce slivers, and twisting and drafting the slivers.

However, there have been problems in that conventional leather fibers have problems in that they are difficult to manufacture as spun yarns with an average length of about 10 mm, and physical properties such as tensile strength are not high due to leather fibers with a short length.

That is, lengths of the leather fibers required to manufacture yarns such as leather sheets or spun yarns are different from each other. More specifically, it is advantageous to use leather fibers having a short length as a material for manufacturing leather seats, manufacturing of composite yarns can also be possible by combining fine leather fibers with monofilaments, and it is advantageous to use leather fibers having a long length as a material for manufacturing yarns such as spun yarn. However, since conventionally obtained leather fibers are bundled with leather fibers having different lengths, and it is not easy to sort them by length, a technique for sorting them more easily is required.

Therefore, in order to solve the above-described problems, the present inventors sorted leather fibers using a perforated net, and at this time, the present disclosure was completed by finding that the leather fibers can be sorted by length very easily.

### DISCLOSURE

### Technical Problem

The present disclosure has been made to solve the problems of the conventional technology, and an object of the present disclosure is to provide leather fibers having different lengths obtained by using a perforated net.

Another object of the present disclosure is to provide a method for manufacturing leather fibers having the different lengths.

### Technical Solution

As a technical means for achieving the above-described technical problem, one aspect of the present disclosure provides leather fibers having different lengths, wherein the leather fibers have an average length of 20 mm or more, and based on the number of the total leather fibers obtained, leather fibers having a length of more than 50 mm have a content ratio of 5% to 20%, leather fibers having a length of 20 mm to 50 mm have a content ratio of 50% to 65%, and leather fibers having a length of 0.1 mm to 20 mm have a content ratio of 15% to 30%.

The leather fibers may be obtained by crushing the leathers to break the inter-fiber binding force, and then passing the shredded leathers through a perforated net having hole sizes of different diameters, respectively, to obtain leather fibers of groups having different lengths.

The leather fibers having a length of more than 50 mm may be obtained using a perforated net having a hole size of 50 mm in diameter.

The leather fibers having a length of 20 mm to 50 mm may be obtained using a perforated net having a hole size of 20 mm to 40 mm in diameter.

The leather fibers having a length of 0.1 mm to 20 mm may be obtained using a perforated net having a hole size of 10 mm to 15 mm in diameter.

The leather fibers may have at least one crimp.

The leather fibers may have a thickness of 0.01 mm to 0.25 mm.

Furthermore, another aspect of the present disclosure provides a method for manufacturing leather fibers having different lengths, the method including the steps of: sorting leathers by color; dissociating the binding force in the leathers by injecting the sorted leathers into a milling machine, respectively; extracting leather fibers from the leathers in which the binding force is dissociated; and sorting the extracted leather fibers by length using a perforated net.

The step of dissociating the binding force in the leathers may be performing treatment for 8 to 16 hours in a milling machine when the KS K ISO 17235 standard softness measurement values of the sorted leathers are 3 mm or less, and performing treatment for 10 to 24 hours in a milling machine when the KS K ISO 17235 standard softness measurement values of the sorted leathers are more than 3 mm.

### Advantageous Effects

Since the leather fibers having different lengths according to the present disclosure as described above can be easily sorted by length using a perforated net, there is an advantage in that leather fibers having different lengths can be used for their suitable uses, respectively.

Further, the length/thickness ratio of the leather fibers is excellent, and thus there is an effect that the thickness can be adjusted.

Further, the leather fibers may be very environmentally friendly since they uses leathers that are discarded after cutting.

### DESCRIPTION OF DRAWINGS

FIG. 1 is a SEM photograph showing leather fibers having different lengths according to one embodiment of the present disclosure.

FIG. 2 is a photograph showing leather fibers having different lengths according to one embodiment of the present disclosure.

FIG. 3 is enlarged photographs showing leather fibers having different lengths according to one embodiment of the present disclosure.

FIG. 4 is photographs showing crimps of leather fibers according to one embodiment of the present disclosure.

FIGS. 5A to 5E are photographs showing leathers sorted by color according to one embodiment of the present disclosure, respectively.

FIG. 6 is a graph showing a length distribution of leather fibers obtained according to one embodiment of the present disclosure.

FIG. 7 is a graph showing a thickness distribution of leather fibers obtained according to one embodiment of the present disclosure.

### BEST MODE FOR CARRYING OUT THE INVENTION

Hereinafter, embodiments of the present disclosure will be described in detail so that those skilled in the art to which the present disclosure pertains can easily implement the present disclosure. However, the present disclosure may be embodied in many different forms and is not limited to the embodiments described herein.

### Example. Manufacture of Leather Fibers with Different Lengths

### 1. Sorting of Leathers

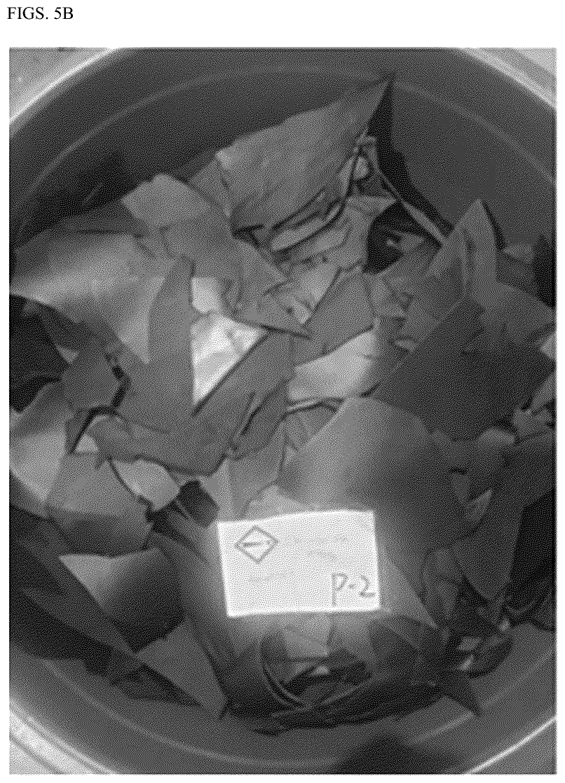

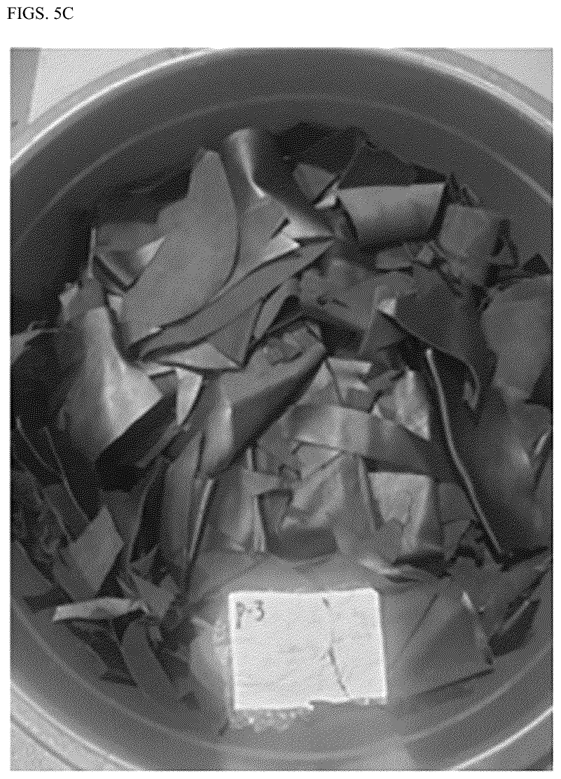

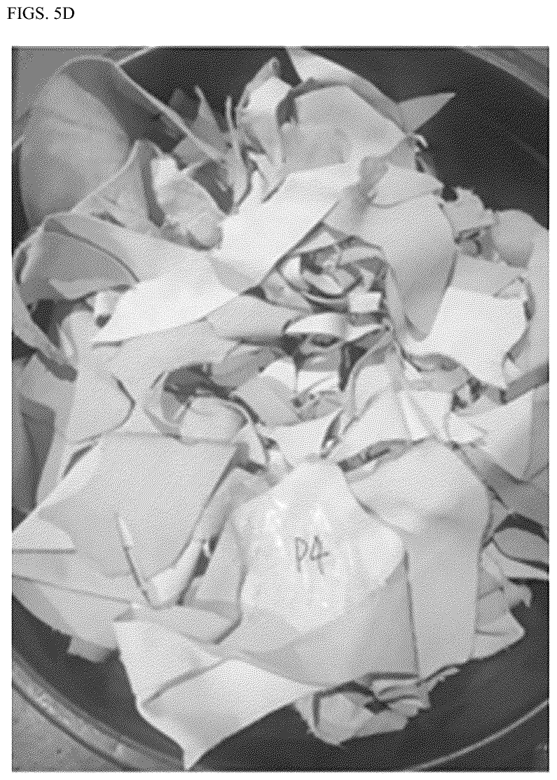

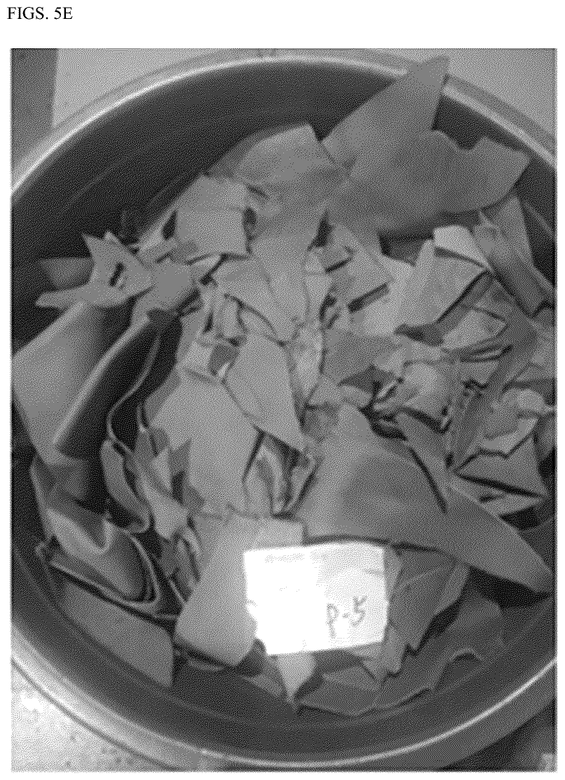

As shown in FIGS. 5A to 5E, pieces of cowhide or the entire cowhide were sorted into similar colors only regardless of type, shape, size, or thickness. At this time, the thickness, softness, and moisture content of the leathers shown in FIGS. 5A to 5E are shown in Table 1 below. At this time, the softness was measured according to KS K ISO 17235 standard. Meanwhile, the leathers shown in FIGS. 5A to 5E were subjected to the same process in subsequent steps, but the content ratios of the finally obtained leather fibers by length were similar. Accordingly, in this embodiment, they will be explained as follows based on the leathers sorted in FIG. 5A.

TABLE 1

| NO. | FIG. 5A | FIG. 5B | FIG. 5C | FIG. 5D | FIG. 5E |
|---|---|---|---|---|---|
| Thickness | 1.5 to 1.7 | 1.3 to 1.5 | 1.3 to 1.5 | 1.5 to 1.7 | 1.6 to 1.8 |
| (mm) | | | | | |
| Softness | 3.8 | 2.5 | 6.2 | 6.0 | 3.3 |
| Moisture | 15.5 | 15.6 | 16.6 | 15.1 | 16.6 |
| content | | | | | |

### 2. Impurity Removal

The impurity areas present in the sorted leathers as described above were cut and washed with water to homogenize the leathers by removing impurities.

### 3. Binding Force Dissociation

The leathers from which the impurities were removed was injected into a milling machine and treated in the milling machine for 18 hours to dissociate the binding force.

### 4. Leather Fiber Extraction

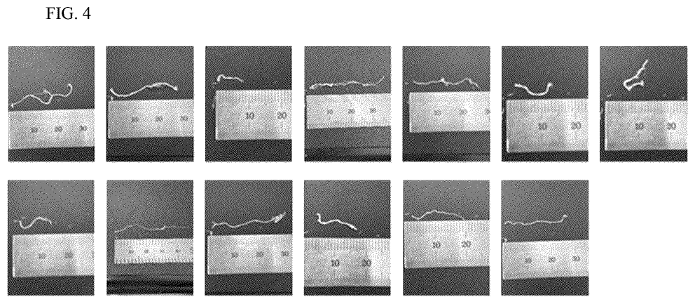

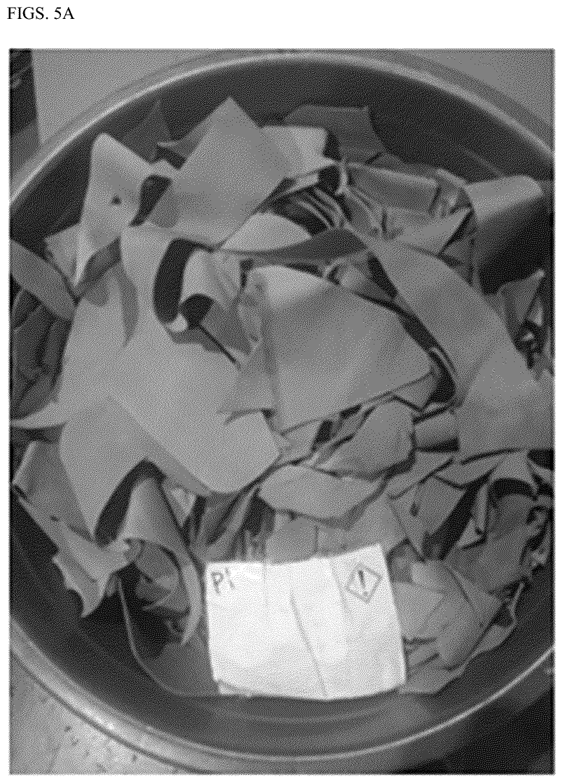

The leathers from which the binding force was dissociated was injected into a leather scraps treatment device of Korean Patent No. 10-1804099, which is a patent owned by the present applicant, to extract leather fibers. The extracted leather fibers had a length of 0.1 mm to 90 mm and a fineness of 0.01 mm to 0.7 mm. At this time, it was confirmed that at least one crimp was formed as shown in FIG. 4 in the extraction process as described above, and accordingly, it could be confirmed that leather fibers which maintain strong binding force and cohesion properties, and heat retention that has an air layer were extracted.

### 5. Sorting by Length

Leather fibers by length were sorted by passing the extracted leather fibers through a perforated net present at the outlet of Korean Patent No. 10-1804099, which is a patent owned by the present applicant.

More specifically, the leather fibers that did not pass through it were sorted by passing the entire leather fibers through a perforated net having a hole size of 50 mm in diameter, and the length of the leather fibers sorted as described above is a length of 50 mm to 90 mm.

Thereafter, the leather fibers that did not pass through it were sorted by passing the leather fibers that did pass through it as described above through a perforated net having a hole size of 20 mm to 40 mm in diameter, and the leather fibers sorted as described above had a length of 20 mm to 50 mm.

Next, the leather fibers that did not pass through it and leather fibers that did pass through it were sorted by passing the leather fibers that did pass through it as described above through a perforated net having a hole size of 10 mm to 15 mm in diameter, and the leather fibers that did not pass through it had a length of 20 mm to 50 mm, and the leather fibers that did pass through it had a length of 0.1 mm to 20 mm.

### Experimental Example 1. Measurement of Length Distribution of Leather Fibers

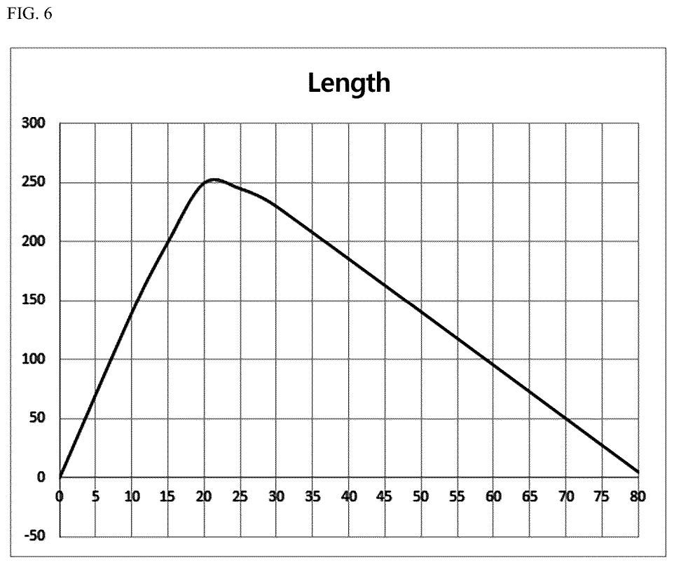

The number of leather fibers having each length sorted in the above Example was measured and shown in FIG. 6. At this time, in FIG. 6, the x-axis represents the length (mm) of leather fibers, and the y-axis represents the number of leather fibers. Meanwhile, the total number of leather fibers used in the distribution by length was 3,000, of which the number of leather fibers having a length of 0.1 mm to 20 mm was 810, and the number of leather fibers having a length of 20 mm to 50 mm was 1,800, and the number of leather fibers having a length of 50 mm to 90 mm was 390.

That is, the leather fibers according to the present disclosure may be easily sorted by length using a perforated net, and it could be confirmed that they may be more suitably applied as leather spun yarn uses by retaining also 13% of leather fibers with an average length of 20 mm or more and a length of more than 50 mm.

### Experimental Example 2. Measurement of Thickness Distribution of Leather Fibers

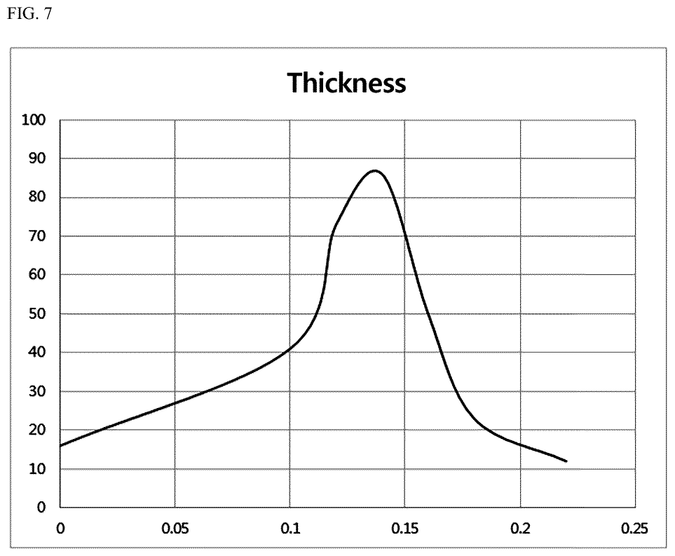

Respective thicknesses of the leather fibers obtained in the above Example were measured and are shown in FIG. 7. At this time, in FIG. 7, the x-axis represents the thickness (mm) of leather fibers, and the y-axis represents the number of leather fibers. Meanwhile, the total number of leather fibers used in the distribution by thickness was 303, and as shown in FIG. 7, it could be confirmed that the number of leather fibers having a thickness of 0.1 mm to 0.2 mm was the largest. Therefore, it could be confirmed that they may be more suitably used as leather spun yarn uses since they have a large length/thickness ratio of the leather fibers by including a lot of leather fibers having a thin thickness.

### Mode for Carrying Out the Invention

Hereinafter, the present disclosure will be described in more detail. However, the present disclosure can be implemented in many different forms, and the present disclosure is not limited by the embodiments described herein, and the present disclosure is only defined by the claims to be described later.

In addition, terms used in the present disclosure are only used to describe specific embodiments, and are not intended to limit the present disclosure. Singular expressions include plural expressions unless the context clearly dictates otherwise. In the entire specification of the present disclosure, ‘including’ a certain element means that other elements may be further included without excluding other elements unless specifically stated otherwise.

A first aspect of the present application provides leather fibers having different lengths, wherein the leather fibers have an average length of 20 mm or more, and based on the number of the total leather fibers obtained, leather fibers having a length of more than 50 mm have a content ratio of 5% to 20%, leather fibers having a length of 20 mm to 50 mm have a content ratio of 50% to 65%, and leather fibers having a length of 0.1 mm to 20 mm have a content ratio of 15% to 30%.

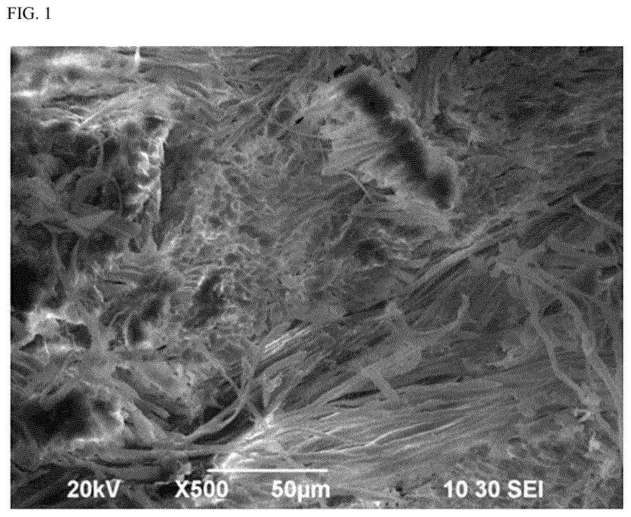

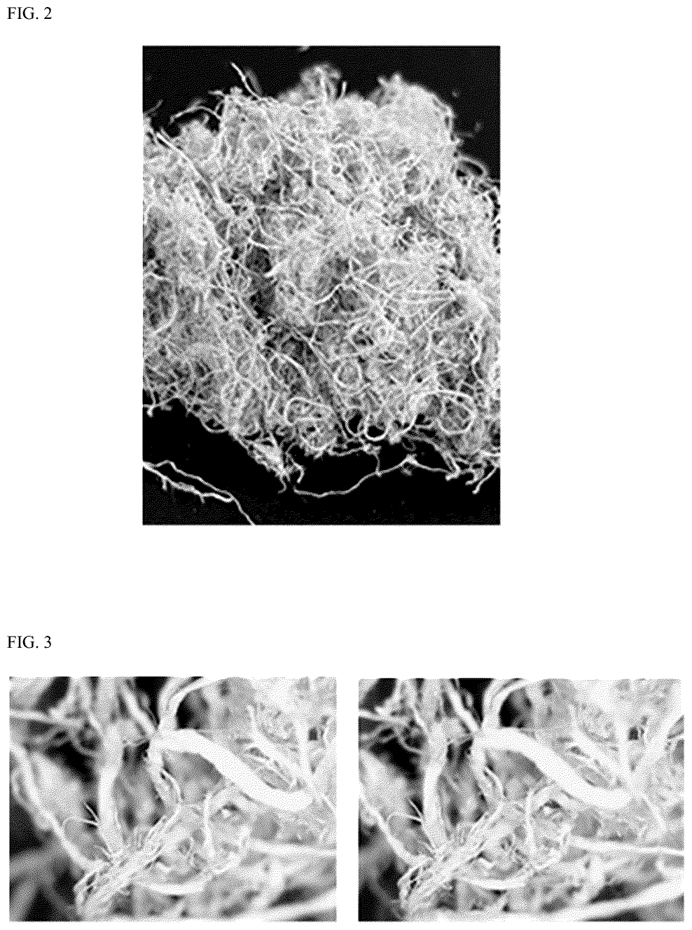

Hereinafter, the leather fibers having different lengths according to the first aspect of the present application will be described in detail with reference to FIGS. 1 to 4. At this time, FIGS. 1 to 3 are SEM photographs or general photographs showing leather fibers having different lengths, respectively, and FIG. 4 is photographs showing crimps of the leather fibers.

Meanwhile, since the configurations shown in FIGS. 1 to 4 are only one embodiment, it should be understood that modification of some forms or substitution of components is all included within a range that does not impair the scope of rights of the present disclosure.

In one embodiment of the present application, the leather fibers may have an average length of 20 mm or more, and based on the total number of leather fibers obtained, leather fibers having a length of 20 mm or more may have a content of 55% or more. Meanwhile, in the leather fibers, the leather fibers having a length of more than 50 mm may have a content ratio of 5% to 20%, the leather fibers having a length of 20 mm to 50 mm may have a content ratio of 50% to 65%, and the leather fibers having a length of 0.1 mm to 20 mm may have a content ratio of 15% to 30%. More preferably, the leather fibers having a length of more than 50 mm may have a content ratio of 10% to 15%, the leather fibers having a length of 20 mm to 50 mm may have a content ratio of 55% to 65%, and the leather fibers having a length of 0.1 mm to 20 mm may have a content ratio of 25% to 30%. According to one embodiment of the present disclosure, the leather fibers having a length of more than 50 mm may have a content ratio of 13%, the leather fibers having a length of 20 mm to 50 mm may have a content ratio of 60%, and the leather fibers having a length of 0.1 mm to 20 mm may have a content ratio of 27%. Meanwhile, the leather fibers having a length of 20 mm to 50 mm may mean leather fibers having a length of more than 20 mm to 50 mm or less, and the leather fibers having a length of 0.1 mm to 20 mm may mean leather fibers having a length of 0.1 mm or more to 20 mm or less.

In one embodiment of the present application, since the leather fibers have an average length of 20 mm or more, it may be preferable to mainly use them as a material for yarn, and in the case of leather fibers having a length of less than 20 mm, they may be used as materials for leather web sheets or may be used to manufacture composite yarns by being combined with monofilaments. In addition, it may be possible to manufacture them into composite yarns by mixing the leather fibers with natural vegetable fibers, natural protein fibers, or natural mineral fibers. That is, the leather fibers according to the present disclosure can be appropriately utilized as materials for articles suitable for respective length ranges regardless of length.

In one embodiment of the present application, the types of yarns may be, for example, a spun yarn, a weaving yarn, a knitting yarn, a lace yarn, an embroidery yarn, a sewing yarn, etc., and may include all of, depending on twisting conditions, a left-handed twisted (S twisted) yarn, a right-handed twisted (Z twisted) yarn, an S covering yarn, a Z covering yarn, an X covering yarn, a sweet twisted yarn (H #kit), a soft twisted yarn, a cotton yarn, a hard twisted yarn, a super twisted yarn, a single play yarn, a single twisted yarn, a ply yarn, a fancy yarn, and the like.

At this time, the spun yarn may be manufactured by arranging the leather fibers to be neatly intertwined in the direction of the fiber axis to perform a carding process and finally twisting them. In addition, the weaving yarn may be a yarn used to manufacture fabric, knitting yarn may be a yarn used to manufacture knitted fabric, lace yarn may be a yarn used to manufacture lace, embroidery yarn may be a yarn used when performing embroidering, and sewing yarn may be a yarn used when performing sewing.

The left-handed twisted yarn may be a yarn in which the direction of twist proceeds from right to left, and thus the oblique line of a leather fiber is placed in the same direction as the character “S”, and the right-handed twisted yarn may be a yarn in which the direction of twist proceeds from left to right, and thus the oblique line of a leather fiber is placed in the same direction as the character “Z”. In addition, the S covering yarn may refer to a yarn covered in an “S” shape on the left-handed twisted yarn or right-handed twisted yarn by post-processing, the Z covering yarn may refer to a yarn covered with a “Z” shape, and the X covering yarn may refer to an “X” shape, that is, a yarn that has performed both of the S covering and the Z covering. In addition, a sweet twisted yarn is a yarn made by slightly performing twisting, the soft twisted yarn is a yarn made by performing twisting 300 times or less per 1 m of yarn, and a cotton yarn is a yarn made by performing twisting 300 to 1,000 times and may be frequently used in the spun yarn. The hard twisted yarn is a yarn made by performing twisting 800 to 3,000 times, and a super twisted yarn is a yarn made by performing twisting 2,000 times or more, and may be used as a yarn for an area shrunk fabric.

The single play yarn is a single yarn or a yarn that has not been subjected to a twisting operation, and may be applied to a crude silk yarn or all yarns spun from a spinneret. In addition, a sheet twisted yarn refers to a lightly twisted yarn, and may be a yarn made by adding several single play yarns. At this time, a two-ply twisted yarn may be referred to as a two-ply yarn, and adding two plies of the two-ply yarn may be referred to as a cord or a rope. In a ply yarn, there can be many cases where the lower yarn is usually a right-handed twist and the upper yarn is a left-handed twist. Three-ply yarn is often used for sewing yarn, but it may be also possible to use nine-ply yarn. The fancy yarn may be a yarn made by twisting and intertwining heart yarn ( [symbol] ), decorative yarn ( [symbol] ), and binding yarn ( [symbol] ) of different thicknesses, colors, lengths, tensions, etc.

In addition, it may be divided into thick yarn, fine yarn, etc. depending on the thickness of a yarn, and a short-cut yarn may be referred to as a split-type composite yarn (split yarn).

At this time, the leather fibers having a length of less than 20 mm may be used for manufacturing flocking yarns, and leather fibers having a short length but thick thickness may be used for manufacturing neb yarns. That is, the leather fibers having a length of less than 20 mm are not necessarily used only as a material for manufacturing leather sheets, but may be used as a material for some yarns, and in the case of fine leather fibers, may be used to manufacture composite yarns by being combined with monofilaments. At this time, the fine leather fibers and monofilaments may have a weight mixing ratio of 1:9 to 9:1, and in the case of the leather fibers having a length of 20 mm to 50 mm, they may be mixed with natural fibers for spinning and stable fibers for synthetic fiber spinning and used as a material for spun yarn. In addition, in the case of the leather fibers having a length of more than 50 mm according to one embodiment of the present disclosure, it may be possible to use them as a spinning yarn material at a 100% ratio.

In one embodiment of the present application, after leathers of the leather fibers are shredded to destroy the inter-fiber binding force, the shredded leathers may pass through a perforated net having hole sizes of different diameters, respectively, to obtain leather fibers of a group having different lengths. To this end, a leather scraps treatment device of Korean Patent No. 10-1804099, which is a patent owned by the present applicant, may be utilized.

In one embodiment of the present application, the leather fibers having a length of more than 50 mm may be obtained using a perforated net having a hole size of 50 mm in diameter, the leather fibers having a length of 20 mm to 50 mm may be obtained using a perforated net having a hole size of 20 mm to 40 mm in diameter, and the leather fibers having a length of 0.1 mm to 20 mm may be obtained using a perforated net having a hole size of 10 mm to 15 mm in diameter. More specifically, the leather fibers having a length of more than 50 mm may be obtained by passing the entire obtained leather fibers through a perforated net having a hole size of 50 mm in diameter and sorting the leather fibers that have not passed through it. In addition, the leather fibers having a length of 20 mm to 50 mm may be obtained by passing the remaining leather fibers except for the leather fibers having a length of more than 50 mm through a perforated net having a hole size of 20 mm to 40 mm in diameter and sorting the leather fibers that have not passed through it. In addition, the leather fibers having a length of 0.1 mm to 20 mm may be obtained by passing the remaining leather fibers except for the leather fibers having a length of more than 50 mm and the leather fibers having a length of 20 mm to 50 mm through a perforated net having a hole size of 10 mm to 15 mm in diameter and sorting the leather fibers that have passed through it, and the leather fibers that have not passed through it may be sorted as leather fibers having a length of 20 mm to 50 mm. That is, the leather fibers according to the present disclosure may be obtained in a state in which several strands of leather fibers form one lump in the initial state obtained as shown in FIGS. 1 to 3, and they can be easily sorted by length by sequentially passing them through a perforated net having hole sizes in different diameters.

In one embodiment of the present application, the leather fibers may have at least one crimp as shown in FIG. 4. At this time, the crimp may mean the twist existing in the leather fibers, which means that the leather fibers have very strong cohesion properties and have a small gap and an air layer between the microfibers, and the crimp may be formed in the process of physical regeneration. Accordingly, the leather fibers may be disposed in hardness and may be entangled with each other by their own crimp.

Meanwhile, the leather fibers may be extracted from cowhide, and when the cowhide is manufactured after slaughtering, leather pieces of the cow skin may be generated in the process of cutting, cutting off, and trimming defective surfaces while going through surface coating, heat processing, drying, embossing, and top processing after going through the existing leather tanning process (tanning process, lime treatment, washing, demineralization, tanning and softening process, dehydration process) and performing tanning. The leathers may be any types of leathers such as full grain, top grain, aniline, suede, nubuck, sprit, pigment leather, etc., and thickness, hardness, size, etc. may be irrelevant to the conditions for fiber production. In addition, there is no limitation as long as they are in the form of leathers with the thickness of a solid piece form, and they may be applicable if only leathers are collected separately from leather cutting scraps or discarded leather products (sneakers, bags, leather jackets, etc.) in the process of manufacturing products.

In one embodiment of the present application, the leather fibers may have a thickness of 0.01 mm to 0.25 mm. At this time, the thickness range with the largest content ratio may be 0.1 mm to 0.2 mm, and as described above, the leather fibers may be used as a material for yarn even if they have a short length depending on the thickness. If the thickness of the leather fibers is more than 0.25 mm, it may be difficult to control the thickness in the process of manufacturing the yarn and the tactile sensation may be impaired, and if it is less than 0.01 mm, a problem of deterioration in processability may occur.

Hereinafter, details related to leather fibers used in the manufacture of leather spun yarn will be described in detail.

In one embodiment of the present application, in general, the spun yarn prevents the yarn from unraveling due to frictional force between fibers to maintain the state of the yarn, and the longer the length of the fibers to be contained is, the higher the frictional force may become so that the more the strength may be improved. Therefore, since the leather fibers according to the present disclosure have an average length of 20 mm or more, they may be contained in the leather spun yarn to improve the frictional force between the leather fibers. In addition, since the content of the leather fibers having a length of 20 mm or more is 55% or more, a large amount of leather fibers having a longer length may be contained, and thus the frictional force between the fibers may be further improved.

In one embodiment of the present application, since the larger the length/thickness ratio of the leather fibers means the longer and thinner leather fibers, the processability is improved, and since it is easy to control the thickness of the leather spun yarn, the length/thickness ratio of the leather fibers according to the present disclosure may be preferably 130 or more. At this time, in order to improve smoothness of thickness control and physical properties of the leather spun yarn, leather fibers having a length/thickness ratio exceeding 200 may have a content of 15% or more. That is, since the higher the fiber content of the leather fibers having the length/thickness ratio exceeding 200, the more long and thin leather fibers are contained, processability and physical properties may be improved.

In one embodiment of the present application, the leather fibers are obtained from leathers, and the leathers have a certain length as piece/plate-shaped scraps, and thus the fiber form can be extracted. In addition, it may be preferable to obtain leather fibers using scraps having a length of one surface of about 100 mm or more and an area of 50 to 250 cm2 in order to obtain long leather fibers as the leather fibers.

In one embodiment of the present application, various leathers such as cowhide, sheepskin, and pigskin may be used as the leathers, but since sheepskin or pigskin is thinner and has lower strength than cowhide, and thus the leather fibers are formed to have a too short length and it may be difficult to manufacture them into the spun yarn, it may be desirable to extract leather fibers from cowhide.

In one embodiment of the present application, although the leather fibers for leather spun yarn contain long leather fibers and can form leather spun yarn with a leather fiber content of 100%, they may be used together with natural fibers, recycled fibers, and synthetic fibers depending on the use and purpose of the leather spun yarn so that it may be possible to manufacture them into leather spun yarn.

The leather fibers contained in the leather spun yarn is preferably contained in an amount of 10% by weight or more, and when they are contained in an amount of less than 10% by weight, sensibility such as a unique touch or the like of leathers may deteriorate.

In one embodiment of the present application, the leather spun yarn may be manufactured using a carding machine, a drawing machine, a roving machine, and a spinning machine, and may be manufactured by a general spun yarn manufacturing process.

As described above, the leather spun yarn containing long leather fibers has improved physical properties and may be used for various leather articles.

The second aspect of the present application provides a method for manufacturing leather fibers having different lengths, the method including the steps of: sorting leathers by color; dissociating the binding force in the leathers by injecting the sorted leathers into a milling machine, respectively; extracting leather fibers from the leathers in which the binding force is dissociated; and sorting the extracted leather fibers by length using a perforated net.

Although detailed descriptions of portions overlapping with those of the first aspect of the present application have been omitted, the contents described for the first aspect of the present application can be equally applied even if the description is omitted from the second aspect.

Hereinafter, the method for manufacturing leather fibers having different lengths according to the second aspect of the present application will be described in detail step by step.

First, in one embodiment of the present application, the above-described method for manufacturing leather fibers having different lengths may include a step of sorting leathers by color.

In one embodiment of the present application, the leathers may preferably be cowhide, and cowhide pieces or the entire cowhide may be used. Meanwhile, the sorting by color may simply be performing sorting into similar colors regardless of the type, shape, size, thickness, etc. of leathers. This may be because leathers having similar colors have similar softness measurement values as will be described later in the binding force dissociation step afterward.

Next, in one embodiment of the present application, the method for manufacturing leather fibers having different lengths may include a step of removing impurities from the sorted leathers. At this time, the impurities may mean a leather with a worn and frayed surface, impurities being present, or a part which is smeared with the dye because the coating processing is not perfectly performed, and may be a process of removing and homogenizing them. Meanwhile, the method of removing the impurities is not particularly limited, and for example, a method of removing the impurities so that the leather is washed or a related part is cut may be used.

Next, in one embodiment of the present application, the method for manufacturing leather fibers having different lengths may include a step of dissociating the binding force in the leathers by injecting the leathers from which the impurities have been removed into a milling machine, respectively.

In one embodiment of the present application, the step of dissociating the binding force in the leathers may be performing treatment for 8 to 16 hours in a milling machine when the KS K ISO 17235 standard softness measurement values of the sorted leathers are 3 mm or less, and performing treatment for 10 to 24 hours in a milling machine when the KS K ISO 17235 standard softness measurement values of the sorted leathers are more than 3 mm. That is, since when the softness measurement values are high, it means that the softness of the leathers is low, the treatment time in the milling machine may be increased. The leathers whose binding force is dissociated as described above may be expanded by opening the gap between the leather fibers.

Next, in one embodiment of the present application, a step of extracting leather fibers from the leathers in which the binding force is dissociated may be included.

In one embodiment of the present application, the cowhide expanded as described above may be injected into the leather scraps treatment device of Korean Patent No. 10-1804099, which is a patent owned by the present applicant, and may be extracted as leather fibers with a length of 0.1 mm to 90 mm and a fineness of 0.01 mm to 0.7 mm. At this time, at least one crimp may be formed in the extraction process as described above to extract leather fibers which maintain strong binding force and cohesion properties, and heat retention that has an air layer.

Next, in one embodiment of the present application, a step of sorting the extracted leather fibers by length using a perforated net may be included.

In one embodiment of the present application, the leather fibers having a length of more than 50 mm may be obtained using a perforated net having a hole size of 50 mm in diameter, the leather fibers having a length of 20 mm to 50 mm may be obtained using a perforated net having a hole size of 20 mm to 40 mm in diameter, and the leather fibers having a length of 0.1 mm to 20 mm may be obtained using a perforated net having a hole size of 10 mm to 15 mm in diameter. More specifically, the leather fibers having a length of more than 50 mm may be obtained by passing the entire obtained leather fibers through a perforated net having a hole size of 50 mm in diameter and sorting the leather fibers that have not passed through it. In addition, the leather fibers having a length of 20 mm to 50 mm may be obtained by passing the remaining leather fibers except for the leather fibers having a length of more than 50 mm through a perforated net having a hole size of 20 mm to 40 mm in diameter and sorting the leather fibers that have not passed through it. In addition, the leather fibers having a length of 0.1 mm to 20 mm may be obtained by passing the remaining leather fibers except for the leather fibers having a length of more than 50 mm and the leather fibers having a length of 20 mm to 50 mm through a perforated net having a hole size of 10 mm to 15 mm in diameter and sorting the leather fibers that have passed through it, and the leather fibers that have not passed through it may be sorted as leather fibers having a length of 20 mm to 50 mm. That is, the extracted leather fibers may be ones extracted in a state in which several strands of leather fibers form one lump as shown in FIGS. 1 to 3, and they can be easily sorted by length by sequentially passing them through a perforated net having hole sizes in different diameters.

### INDUSTRIAL APPLICABILITY

Since the leather fibers having different lengths according to the present disclosure as described above can be easily sorted by length using a perforated net, there is an advantage in that the respective leather fibers having different lengths can be used for their suitable uses.

In addition, since the length/thickness ratio of the leather fibers is excellent, there is an effect of enabling the thickness to be adjusted.

In addition, the leather fibers may be very environmentally friendly since they use leathers that are discarded after cutting.

1. Leather fibers having different lengths, wherein the leather fibers have an average length of 20 mm or more, and based on the number of the total leather fibers obtained, leather fibers having a length of more than 50 mm have a content ratio of 5% to 20%, leather fibers having a length of 20 mm to 50 mm have a content ratio of 50% to 65%, and leather fibers having a length of 0.1 mm to 20 mm have a content ratio of 15% to 30%.

2. The leather fibers having different lengths of claim 1, wherein the leather fibers are obtained by crushing the leathers to break the inter-fiber binding force, and then passing the shredded leathers through a perforated net having hole sizes of different diameters, respectively, to obtain leather fibers of groups having different lengths.

3. The leather fibers having different lengths of claim 2, wherein the leather fibers having a length of more than 50 mm are obtained using a perforated net having a hole size of 50 mm in diameter.

4. The leather fibers having different lengths of claim 2, wherein the leather fibers having a length of 20 mm to 50 mm are obtained using a perforated net having a hole size of 20 mm to 40 mm in diameter.

5. The leather fibers having different lengths of claim 2, wherein the leather fibers having a length of 0.1 mm to 20 mm are obtained using a perforated net having a hole size of 10 mm to 15 mm in diameter.

6. The leather fibers having different lengths of claim 1, wherein the leather fibers have at least one crimp.

7. The leather fibers having different lengths of claim 1, wherein the leather fibers have a thickness of 0.01 mm to 0.25 mm.

8. A method for manufacturing leather fibers having different lengths, the method comprising the steps of:
sorting leathers by color;
dissociating the binding force in the leathers by injecting the sorted leathers into a milling machine, respectively;
extracting leather fibers from the leathers in which the binding force is dissociated; and
sorting the extracted leather fibers by length using a perforated net.

9. The method of claim 8, wherein the step of dissociating the binding force in the leathers is performing treatment for 8 to 16 hours in a milling machine when the KS K ISO 17235 standard softness measurement values of the sorted leathers are 3 mm or less, and performing treatment for 10 to 24 hours in a milling machine when the KS K ISO 17235 standard softness measurement values of the sorted leathers are more than 3 mm.
